(19) United States
(12) Patent Application Publication
(10) Pub. No.: US 2018/0268375 A1
(43) Pub. Date: Sep. 20, 2018

(54) METHOD AND APPARATUS FOR REPAIR OR MAINTENANCE CONTROL OF DEVICES

(71) Applicant: Nokia Technologies Oy, Espoo (FI)

(72) Inventors: Henri PASSILA, Espoo (FI); Niko KIUKKONEN, Veikkola (FI)

(73) Assignee: Nokia Technologies OY, Espoo (FI)

(21) Appl. No.: 15/760,725

(22) PCT Filed: Sep. 16, 2015
(86) PCT No.: PCT/FI2015/050619

§ 371 Date: Mar. 16, 2018

(51) Int. Cl. G06Q 10/00; H04L 29/08

(52) U.S. Cl. CPC G06Q 10/20; G06F 3/048; H04L 67/10

(57) ABSTRACT

A method and apparatus having local communication with a proximate device; user interfacing with a user of the apparatus; mobile communication with a back-end server; identifying the proximate device using the local communication and receiving status information from the proximate device; presenting to the user an indication of the status of the proximate device; receiving from the user a request for repair or maintenance information relating to the proximate device; signaling with mobile communication to a back-end server an indication of the status of the proximate device, information relating to the user and a direct or indirect indication of properties of the proximate device and to responsively receive from the back-end server corresponding repair or maintenance information; and presenting of the received repair or maintenance information to the user before repair or maintenance of the proximate device is performed according to the repair or maintenance information.

### TECHNICAL FIELD

The present application generally relates to repair or maintenance control of devices.

### BACKGROUND

This section illustrates useful background information without admission of any technique described herein representative of the state of the art.

Through the development of mankind, people have invented new devices ranging from wheelbarrow to excavators and digital gadgets, for example. Within each device category, there are also numerous different makes and models that vary by their features and construction. Modern devices typically employ computer technology for controlling any sequences of events, although there are still some devices with mechanical sequencing components such as mechanical dish washing machine program dials.

The variety of different devices has vastly increased in all fields of technology and use, including domestic use and industrial use in general (including agricultural use). In case of domestic devices, the production of new devices has become that cost effective that often broken devices are simply replaced by new ones. Expensive domestic devices and the industrial devices are typically maintained by regular service and repaired when they break down. To this end, larger firms tend to have large maintenance departments and/or large number of outsourced technicians serving to maintain and repair devices needed for manufacture of goods, for example. These people are typically specialized in construction, machine technology, electricity, electronics or computing so that, for example, even a small forklift accident may require repair by multiple people of different departments. In the best case, the repair is complete when a technician of each department needed for the repair has performed his or her part so that the longest queue among the needed departments and the repair time of its technician determines defines the down-time. Often, however, the different departments must work with the repair in a particular order so that the total delay may significantly exceed the sum of the queue and repair delays incurred by these different departments.

Various devices also provide for self-diagnostics that helps to identify and correct or repair typical error situations such as a paper jam in a copy machine or low engine oil level in a car. Such procedures are, however, limited to the situations readily programmed in the device in question and to devices that have a sufficient user interface. Using the car example, there are also diagnostics tools that can be connected with a data bus of a car to extract information and perhaps provide the user with some repair or maintenance instructions. Some interface adapters enable a user to obtain information of a car control system by a laptop computer and to provide further information to the user based on instructions stored in the laptop computer. Updates of the instructions may be downloaded from the Internet. Some car control systems are standardized whereas most control circuitries are accessible only using a diagnostics tool that is customized to operate with the make and model in question.

The Internet of Things (IoT) is expected to make numerous devices self-communicative with other devices. The IoT should bring about major improvements in automatic interaction with other devices and services, e.g. by ordering more food in the fridge before desired reserves are exhausted. The IoT also enables automatic exchange of status information and possible automatic updates similarly to present computers that may fetch their updates from the Internet. However, it has been reported that some cars could be maliciously reprogrammed using the update mechanism with potentially dangerous results. The risk of criminal or terrorist attacks may also hinder adoption of automatic maintenance or repair in various secure environments such as hospitals, power plants, prisons, tax offices etc.

It is desired to resolve at some problems of the prior art or to at least provide a new technical alternative.

### SUMMARY

Various aspects of examples of the invention are set out in the claims.

According to a first example aspect of the present invention, there is provided an apparatus comprising: a local communication interface configured to enable communication with a proximate device; a user interface configured to interface with a user of the apparatus; a mobile communication interface configured to enable communication with a back-end server; and a processor configured to cause the apparatus to identify the proximate device using the local communication interface and to receive status information from the proximate device. The processor may be further configured to cause the user interface to present to the user an indication of the status of the proximate device. The processor may be further configured to cause the user interface to receive from the user a request for repair or maintenance information relating to the proximate device. The processor may be further configured to cause the mobile communication interface to signal to a back-end server an indication of the status of the proximate device, information relating to the user and a direct or indirect indication of properties of the proximate device and to responsively receive from the back-end server corresponding repair or maintenance information. The processor may be further configured to cause the user interface to present the received repair or maintenance information to the user before repair or maintenance of the proximate device is performed according to the repair or maintenance information.

According to a second example aspect of the present invention, there is provided a back-end server comprising: a communication interface configured to enable concurrent communications with numerous remote apparatuses; and a processor configured to cause the communication interface to receive from a first apparatus first information comprising an indication of a status of a first proximate device that is proximate to the first apparatus, information relating to a user of the first apparatus and a direct or indirect indication of properties of the first proximate device and to responsively send to the first apparatus corresponding repair or maintenance information. The processor may be further configured to cause the communication interface to receive from a second apparatus second information comprising an indication of a status of a second proximate device that is proximate to the second apparatus, information relating to a user of the second apparatus and a direct or indirect indication of properties of the second proximate device and to responsively send to the second apparatus corresponding repair or maintenance information. The processor may be further configured to determine a first content source based on the first information from a group of numerous content sources. The processor may be further configured to determine a second content source based on the second information from a group of numerous content sources. The processor may be further configured to obtain the repair or maintenance information for the sending to the first apparatus from the first content source. The processor may be further configured to obtain the repair or maintenance information for the sending to the second apparatus from the second content source.

According to a third example aspect of the present invention, there is provided a method comprising: causing local communication with a proximate device; causing user interfacing with a user of the apparatus; causing mobile communication with a back-end server; identifying the proximate device using the local communication and receiving status information from the proximate device; causing presenting to the user an indication of the status of the proximate device; causing receiving from the user a request for repair or maintenance information relating to the proximate device; causing mobile communication to signal to a back-end server an indication of the status of the proximate device, information relating to the user and a direct or indirect indication of properties of the proximate device and to responsively receive from the back-end server corresponding repair or maintenance information; and causing presenting of the received repair or maintenance information to the user before repair or maintenance of the proximate device is performed according to the repair or maintenance information.

According to a fourth example aspect of the present invention, there is provided a method comprising: enabling concurrent communications with numerous remote apparatuses; causing receiving from a first apparatus first information comprising an indication of a status of a first proximate device that is proximate to the first apparatus, information relating to a user of the first apparatus and a direct or indirect indication of properties of the first proximate device and responsively sending to the first apparatus corresponding repair or maintenance information; causing the communication interface to receive from a second apparatus second information comprising an indication of a status of a second proximate device that is proximate to the second apparatus, information relating to a user of the second apparatus and a direct or indirect indication of properties of the second proximate device and to responsively send to the second apparatus corresponding repair or maintenance information; determining a first content source based on the first information from a group of numerous content sources; determining a second content source based on the second information from a group of numerous content sources; obtaining the repair or maintenance information for the sending to the first apparatus from the first content source; and obtaining the repair or maintenance information for the sending to the second apparatus from the second content source.

According to a fifth example aspect of the present invention, there is provided a computer program comprising computer executable program code configured to execute any method of the third or fourth example aspect.

The computer program may be stored in a computer readable memory medium.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

According to a sixth example aspect of the present invention, there is provided an apparatus comprising a memory and a processor that are configured to cause the apparatus to perform the method of the third example aspect.

According to a seventh example aspect of the present invention, there is provided an apparatus comprising a memory and a processor that are configured to cause the apparatus to perform the method of the fourth example aspect.

Different non-binding example aspects and embodiments of the present invention have been illustrated in the foregoing. The embodiments in the foregoing are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1 shows an architectural drawing of a system of an example embodiment;

FIG. 2 shows a simplified block diagram of a device of an example embodiment;

FIG. 3 shows a simplified block diagram of an apparatus of an example embodiment;

FIG. 4 shows a simplified block diagram of a configuration server of an example embodiment;

FIG. 5 shows a simplified block diagram of a back-end server of an example embodiment;

FIG. 6 shows a simplified block diagram of a content source of an example embodiment;

FIGS. 7a to 7c show a flow chart illustrating an example process in an apparatus; and

FIGS. 8a and 8b show a flow chart illustrating an example process in a back-end server.

### DETAILED DESCRIPTION OF THE DRAWINGS

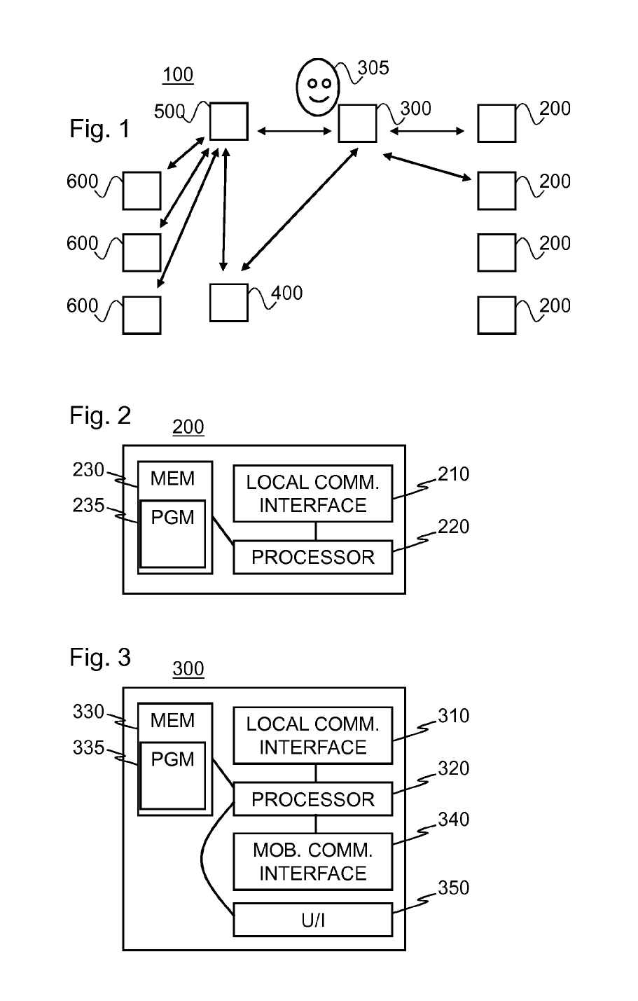

An example embodiment of the present invention and its potential advantages are understood by referring to FIGS. 1 through 8b of the drawings. In this document, like reference signs denote like parts or steps.

FIG. 1 shows an architectural drawing of a system 100 of an example embodiment. The system comprises plurality of devices 200, an apparatus 300, a configuration server 400, a back-end server 500 and numerous content sources 600. The apparatus 300 can be a dedicated apparatus for the function of operating according to one or more embodiments of this document or a multi-purpose apparatus such as a mobile telephone, personal digital assistant, navigation device, electronic book, tablet computer, laptop computer or other portable device with functionality of further operating according to one or more embodiments of this document. In an example embodiment, the devices 200 are various maintenance or repair subjects in industrial environment and/or domestic or office environment and the apparatus 300 is capable of communicating with any proximate devices 200 over a local connection, such as Bluetooth LE. FIG. 1 further shows a user 305 of the apparatus 300.

The devices 200 may be different devices for different purposes, but it is assumed that each of the proximate devices 200 are communicatively connectable with the apparatus 300 over a wired or wireless local connection. The proximate devices 200 need not have any user interface of their own but instead the proximate devices 200 may be user interfacable through the apparatus 300 so as, for example, to study their status or control their operation by the user 305.

FIG. 2 shows a simplified block diagram of the apparatus 200 of an example embodiment. The device 200 comprises a local communication interface 210 that is configured to enable communications with the apparatus 300, a processor 220 and a memory 230 comprising computer executable program code 235 for controlling the processor 220 to cause the device 200 to perform some useful process such as process automation tasks, domestic appliance operation, or vehicular sub-process control. The device 200 may comprise a user interface of its own, but at simplest the device 200 is only user interfacable by the apparatus 300.

FIG. 3 shows a simplified block diagram of the apparatus 300 according to an example embodiment. The apparatus 300 comprises: a local communication interface 310 configured to enable communication with the local communication interface 210 of the proximate device 200; a processor 320 and a memory 330 comprising computer executable program code 335 for controlling the processor 320 to control operation of the apparatus 300; a mobile communication interface 340 configured to enable communication with the back-end server 500; and a user interface 350 configured to interface with the user 305 of the apparatus.

In an example embodiment, the local communication interface 310 is configured to enable communication with any proximate device 200 that is compatible with the local communication interface 310. This may be the case in particular if the local communication interface 310 is a wireless local communication interface, such as, for example, a near field communication interface. The local communication interface 310 may be a Bluetooth 4.0 Low Energy compatible communication interface. In an example embodiment, the local communication interface 310 is a radio frequency identification interface. In an example embodiment, the local communication interface is a 5G mobile communication interface.

In an example embodiment, the local communication interface 310 is a wired communication interface, such as, for example, universal serial bus (USB), an RS-232 or an IEEE-1394 interface.

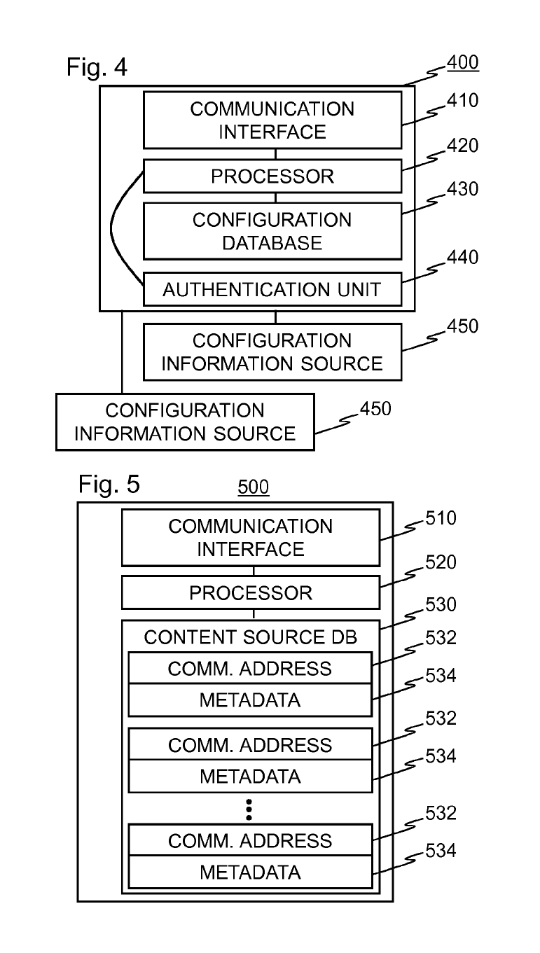

FIG. 4 shows a simplified block diagram of a configuration server of an example embodiment. The configuration server 400 is drawn in FIGS. 1 and 4 as a separate entity. However, in some embodiments, the configuration server 400 is a functionality provided by a server with one or more other functionalities. For example, the configuration server 400 and the back-end server 500 may be hosted by same equipment or by partly same equipment. Moreover, the configuration server may be a distributed entity that is formed of two or more server computers. The configuration server 400 may be maintained by various device vendors or implemented using a number of different servers (physical servers or cloud servers) that each are responsible for devices of one or more device vendors.

The configuration server 400 is drawn with slightly less detail by omitting the memory and software code that it yet has in some example embodiments. In an example embodiment, the configuration server 400 comprises a communication interface 410 for exchanging information with the apparatus 300; a processor 420 for detecting configuration information requests arriving from different apparatuses 300; a configuration database 430 that holds device configuration information such as user interface definitions; and an authentication unit 440 for cryptographic authentication of entities that seek access to the configuration database 430. The processor 420 may be configured to allow access of the configuration database 430 by the apparatuses 300 and by configuration information sources 450 such as workstations of device vendors, subject to successful authentication with the authentication unit 440.

FIG. 5 shows a simplified block diagram of the back-end server 500 of an example embodiment. In an example embodiment, the back-end server 500 comprises: a communication interface 510 configured to enable concurrent communications with numerous remote apparatuses 300; and a processor 520 configured to control operation of the back-end server 500.

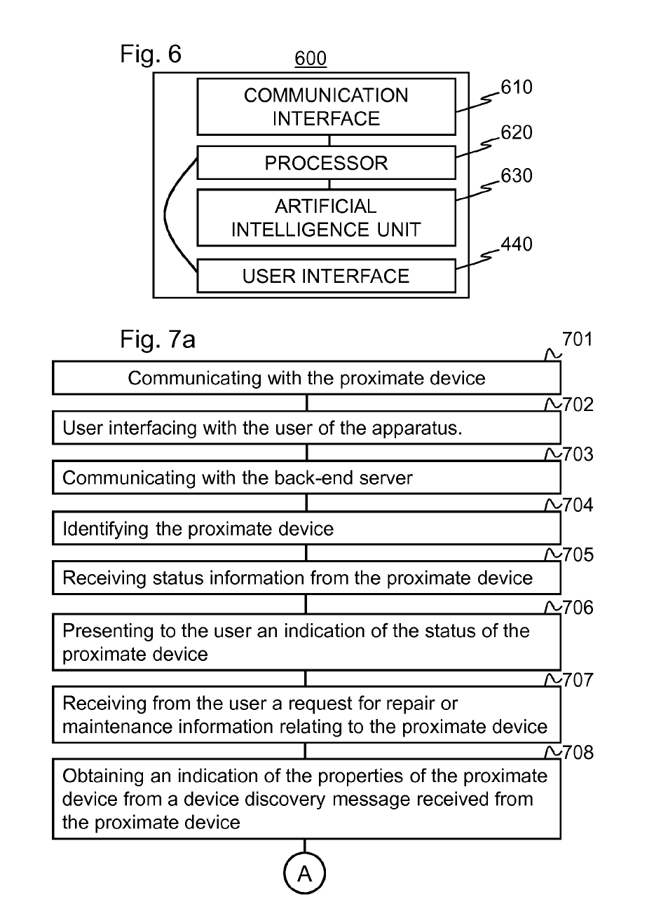

See FIG. 6 and its associated description for various operations that the back-end server 500 may perform under control of the processor 520, for example.

In an example embodiment, the back-end server 500 comprises a content source database 530. The content source database 530 may comprise communication addresses 532 for the numerous content sources 600 and/or metadata 534 for determining the first content source 600 and the second content source 600. The processor 520 may be configured to determine the first content source 600 and the second content source 600 using the content source database 530.

In an example embodiment, the metadata 534 comprises information defining compatibility of different content sources 600 with different devices and error states.

In an example embodiment, the back-end server 500 is a cloud computing hosted functionality. Alternatively, the back-end server 500 is a physical server computer.

In an example embodiment, the repair or maintenance information comprises visually presentable information. The repair or maintenance information may additionally or alternatively comprise one or more proximate device control commands. With such proximate device control commands, the user 305 of the apparatus may be allowed to directly operate the proximate device 200 without need to enter each command by herself after having been able to review the commands. For review, each command may be representable in a human understandable form such as in a pseudo command language or as a graphical user interface animation sequence.

In an example embodiment, there is provided a system that comprises the apparatus 300 of any embodiment of this document and the back-end server 500 of any embodiment of this document. The system may comprise a subset of the numerous content sources 600. The subset may comprise some or all of the numerous content sources 600. The subset of content sources 600 may comprise one or more workstation computers in a communicative connection with the back-end server 500. The subset of content sources 600 may comprise one or more computer terminals in a communicative connection with the back-end server 500. In an example embodiment, the subset of content sources 600 comprises one or more artificial intelligence units.

FIG. 6 shows a simplified block diagram of a content source 600 of an example embodiment. The content source 600 comprises a communication interface 610 configured to communicate with the back-end server 500 and/or with the apparatus 300; a processor 620 for controlling operation of the content source 600; an artificial intelligence unit 630; and/or a user interface 640 for obtaining content from a service adviser who may advise the user 305 of the apparatus 300 on-line or provide recorded content with suitable metadata for automatic delivery by the back-end server 500.

In this document, a communication interface refers to a unit that comprises hardware and possibly software such as one or more processors, analog/digital and/or digital/analog converters, connector(s), antenna(s) and other as such known components for exchanging information.

Any processor referred to by the present document may refer to, for example, any one or more of: a master control unit (MCU); a microprocessor; a digital signal processor (DSP); an application specific integrated circuit (ASIC); a field programmable gate array; and a microcontroller. The memory, on the other hand, is selected from known computer readable media.

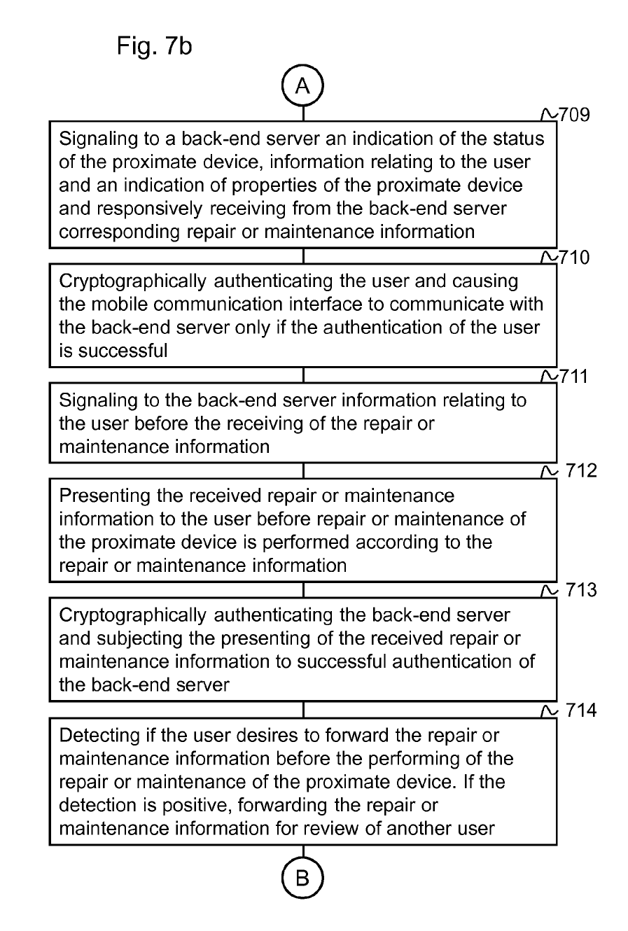

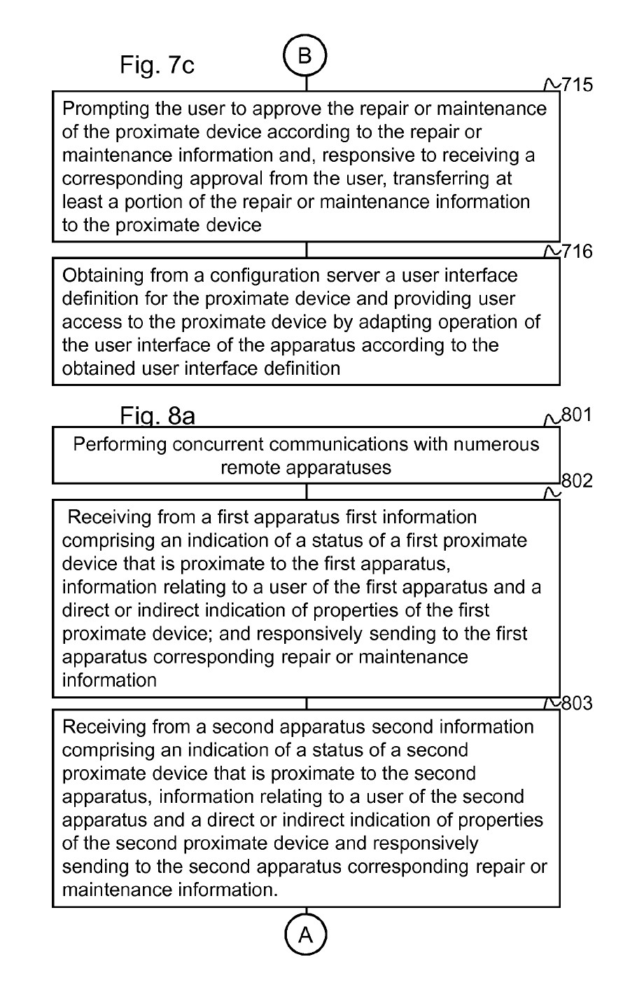

FIGS. 7a to 7c show a flow chart illustrating an example process in an apparatus. FIGS. 7a to 7c presents a number of steps not all of which are necessarily implemented in all embodiments and the order of which is varied in some embodiments. The process comprises:
701. Communicating with the proximate device 200.
702. User interfacing with the user 305 of the apparatus.
703. Communicating with the back-end server 500.
704. Identifying the proximate device 200, using, for example, the local communication interface 310.
705. Receiving status information from the proximate device 200. In an example embodiment, the status information comprises an indication of a present error state. The status information may comprise an indication of a present error type.
706. Presenting to the user 305 an indication of the status of the proximate device 200 using, for example, the user interface 350.
707. Receiving from the user 305 a request for repair or maintenance information relating to the proximate device 200 using, for example, the user interface 350.
708. Obtaining an indication of the properties of the proximate device 200 from a device discovery message received by the local communication interface 310 from the proximate device 200.
709. (FIG. 7b) Signaling to a back-end server 500 an indication of the status of the proximate device 200, information relating to the user 305 and a direct or indirect indication of properties of the proximate device 200 and responsively receiving from the back-end server 500 corresponding repair or maintenance information. The mobile communication interface 350 may be used for this step. In an example embodiment, the indication of the properties of the proximate device 200 comprises the identity of the proximate device 200 or a cryptographic derivative such as a one-directional cryptographic hash code of an identity of the proximate device 200. The indication of the properties of the proximate device 200 may comprise specifications of the proximate device 200.
710. Cryptographically authenticating the user 305 and causing the mobile communication interface to communicate with the back-end server only if the authentication of the user 305 is successful.
711. Signaling to the back-end server information relating to the user 305 before the receiving of the repair or maintenance information. The information relating to the user 305 may comprise an indication of repair or maintenance competence of the user 305. By signaling to the back-end server information relating to the user 305, the back-end server may be enabled to customize the repair and maintenance information suitably for the needs of the user.
712. Presenting the received repair or maintenance information to the user 305 before repair or maintenance of the proximate device 200 is performed according to the repair or maintenance information, using the user interface 350, for example.
713. Cryptographically authenticating the back-end server and subjecting the presenting of the received repair or maintenance information to successful authentication of the back-end server.
714. Detecting if the user 305 desires to forward the repair or maintenance information before the performing of the repair or maintenance of the proximate device 200. If the detection is positive, forwarding the repair or maintenance information for review of another user.
715. (FIG. 7c) Prompting the user 305 to approve the repair or maintenance of the proximate device 200 according to the repair or maintenance information and, responsive to receiving a corresponding approval from the user 305, transferring at least a portion of the repair or maintenance information to the proximate device 200 using the local communication interface 310, for example.
716. Obtaining from a configuration server 400 a user interface 350 definition for the proximate device 200 and providing user access to the proximate device 200 by adapting operation of the user interface 350 of the apparatus according to the obtained user interface 350 definition. The user interface 350 definition may be formatted in a hypertext markup language. In an example embodiment, adapting of the operation of the user interface 350 of the apparatus is dependent on the status of the proximate device 200. For example, the user interface 350 of the apparatus 300 may be adapted for the use of the proximate device and in a context-sensitive manner. This may involve adapting soft-keys or graphical user interface for the needs of controlling or maintaining the proximate device 200.

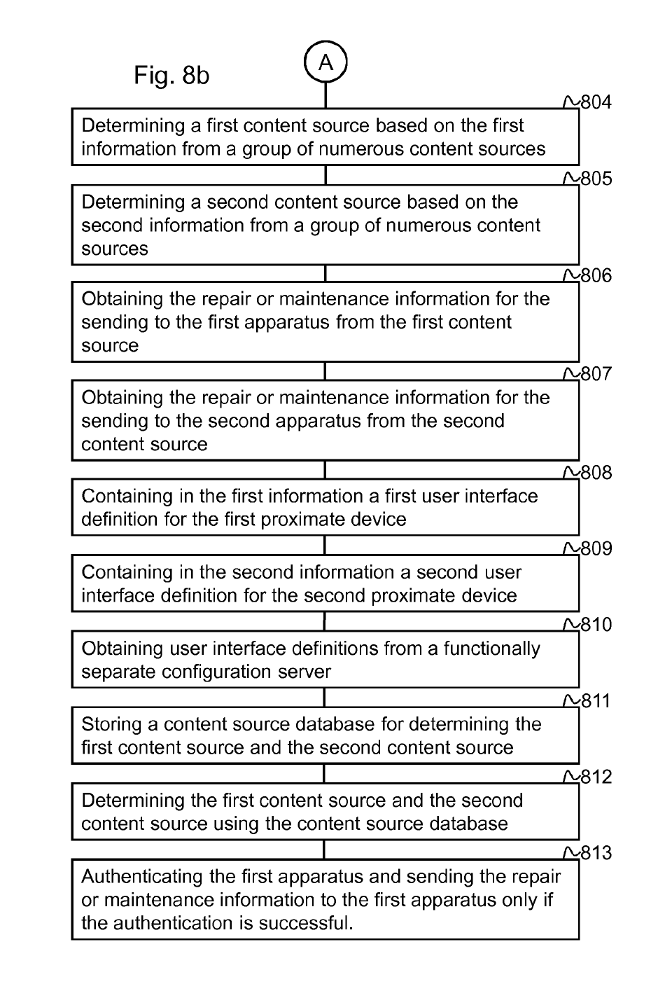

FIGS. 8a and 8b show a flow chart illustrating an example process 800 in a back-end server. The process 800 comprises:
801. Performing concurrent communications with numerous remote apparatuses 300.
802. Receiving from a first apparatus 300 first information comprising an indication of a status of a first proximate device 200 that is proximate to the first apparatus 300, information relating to a user 305 of the first apparatus 300 and a direct or indirect indication of properties of the first proximate device 200; and responsively sending to the first apparatus 300 corresponding repair or maintenance information.
803. Receiving from a second apparatus second information comprising an indication of a status of a second proximate device 200 that is proximate to the second apparatus, information relating to a user 305 of the second apparatus and a direct or indirect indication of properties of the second proximate device 200 and responsively sending to the second apparatus 300 corresponding repair or maintenance information.
804. Determining a first content source 600 based on the first information from a group of numerous content sources 600.
805. Determining a second content source 600 based on the second information from a group of numerous content sources 600.
806. Obtaining the repair or maintenance information for the sending to the first apparatus from the first content source 600.
807. Obtaining the repair or maintenance information for the sending to the second apparatus from the second content source 600.
808. Containing in the first information a first user interface definition for the first proximate device 200, wherein the first user interface definition may be configured to provide user access to the first proximate device 200 by adapting the first apparatus to produce a first user interface for controlling the first proximate device 200.
809. Containing in the second information a second user interface definition for the second proximate device 200, wherein the second user interface definition may be configured to provide user access to the second proximate device 200 by adapting the second apparatus 300 to produce a second user interface for controlling the second proximate device 200.
810. Obtaining user interface definitions from a functionally separate configuration server 400.
811. Storing a content source database 530 that may comprise communication addresses 532 for the numerous content sources 600 and/or metadata 534 for determining the first content source 600 and the second content source 600.
812. Determining the first content source 600 and the second content source 600 using the content source database 530.
813. Authenticating the first apparatus and sending the repair or maintenance information to the first apparatus only if the authentication is successful.

Without in any way limiting the scope, interpretation, or application of the claims appearing below, a technical effect of one or more of the example embodiments disclosed herein is that devices of various types and models may be easily serviceable by one person in extended range of different repair or service situations. Another technical effect of one or more of the example embodiments disclosed herein is that any updates or device configuration changes may be subjected to service personnel review and confirmation so that malicious remote attacks may be prevented or mitigated. Yet another technical effect of one or more of the example embodiments disclosed herein is that numerous users may be simultaneously served with relevant information concerning proximate devices before the users e.g. walk outside of the range of local wireless connection with proximate devices.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a computer described and depicted in FIGS. 3 to 6. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the before-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications which may be made without departing from the scope of the present invention as defined in the appended claims.

1-67. (canceled)

68. An apparatus, comprising:
a local communication interface configured to enable communication with a proximate device;
a user interface configured to interface with a user of the apparatus;
a mobile communication interface configured to enable communication with a back-end server; and
a processor configured to cause the apparatus to identify the proximate device using the local communication interface and to receive status information from the proximate device;
the processor being further configured to cause the user interface to present to the user an indication of the status of the proximate device;
the processor being further configured to cause the user interface to receive from the user a request for repair or maintenance information relating to the proximate device;
the processor being further configured to cause the mobile communication interface to signal to a back-end server an indication of the status of the proximate device, information relating to the user and a direct or indirect indication of properties of the proximate device and to responsively receive from the back-end server corresponding repair or maintenance information;
the processor being further configured to cause the user interface to present the received repair or maintenance information to the user before repair or maintenance of the proximate device is performed according to the repair or maintenance information.

69. The apparatus of claim 68, the processor being further configured to prompt the user to approve the repair or maintenance of the proximate device according to the repair or maintenance information and, responsive to receiving a corresponding approval from the user, to transfer at least a portion of the repair or maintenance information to the proximate device using the local communication interface.

70. The apparatus of claim 68, the processor being further configured to signal to the back-end server the information relating to the user before the receiving of the repair or maintenance information.

71. A back-end server, comprising:
a communication interface configured to enable concurrent communications with numerous remote apparatuses; and
a processor configured to cause the communication interface to receive from a first apparatus first information comprising an indication of a status of a first proximate device that is proximate to the first apparatus, information relating to a user of the first apparatus and a direct or indirect indication of properties of the first proximate device and to responsively send to the first apparatus corresponding repair or maintenance information;
the processor being further configured to cause the communication interface to receive from a second apparatus second information comprising an indication of a status of a second proximate device that is proximate to the second apparatus, information relating to a user of the second apparatus and a direct or indirect indication of properties of the second proximate device and to responsively send to the second apparatus corresponding repair or maintenance information;
the processor being further configured to determine a first content source based on the first information from a group of numerous content sources;
the processor being further configured to determine a second content source based on the second information from a group of numerous content sources;
the processor being further configured to obtain the repair or maintenance information for the sending to the first apparatus from the first content source; and
the processor being further configured to obtain the repair or maintenance information for the sending to the second apparatus from the second content source.

72. The back-end server of claim 71, the processor being further configured to contain in the first information a first user interface definition for the first proximate device, the first user interface definition being configured to provide user access to the first proximate device by adapting the first apparatus to produce a first user interface for controlling the first proximate device.

73. The back-end server of claim 72, the processor being further configured to contain in the second information a second user interface definition for the second proximate device, the second user interface definition being configured to provide user access to the second proximate device by adapting the second apparatus to produce a second user interface for controlling the second proximate device.

74. The back-end server of claim 71, further comprising a content source database, the content source database comprising communication addresses for the numerous content sources and metadata for determining the first content source and the second content source, and the processor being further configured to determine the first content source and the second content source using the content source database.

75. The back-end server of claim 74, wherein the metadata comprises information defining compatibility of different content sources with different devices and error states.

76. The back-end server of claim 71, wherein the repair or maintenance information comprises one or more proximate device control commands

77. The back-end server of claim 71, wherein the processor is further configured to cause authenticating the first apparatus and to cause sending the repair or maintenance information to the first apparatus only if the authentication is successful.

78. A system, comprising:
an apparatus, comprising:
a local communication interface configured to enable communication with a proximate device;
a user interface configured to interface with a user of the apparatus;
a mobile communication interface configured to enable communication with a back-end server; and
a processor configured to cause the apparatus to identify the proximate device using the local communication interface and to receive status information from the proximate device;
the processor being further configured to cause the user interface to present to the user an indication of the status of the proximate device;
the processor being further configured to cause the user interface to receive from the user a request for repair or maintenance information relating to the proximate device;
the processor being further configured to cause the mobile communication interface to signal to a back-end server an indication of the status of the proximate device, information relating to the user and a direct or indirect indication of properties of the proximate device and to responsively receive from the back-end server corresponding repair or maintenance information; and
the processor being further configured to cause the user interface to present the received repair or maintenance information to the user before repair or maintenance of the proximate device is performed according to the repair or maintenance information; and
a back-end server, comprising:
a communication interface configured to enable concurrent communications with numerous remote apparatuses; and
a back-end-server processor configured to cause the communication interface to receive from a first apparatus first information comprising an indication of a status of a first proximate device that is proximate to the first apparatus, information relating to a user of the first apparatus and a direct or indirect indication of properties of the first proximate device and to responsively send to the first apparatus corresponding repair or maintenance information;
the back-end-server processor being further configured to cause the communication interface to receive from a second apparatus second information comprising an indication of a status of a second proximate device that is proximate to the second apparatus, information relating to a user of the second apparatus and a direct or indirect indication of properties of the second proximate device and to responsively send to the second apparatus corresponding repair or maintenance information;
the back-end-server processor being further configured to determine a first content source based on the first information from a group of numerous content sources;
the back-end-server processor being further configured to determine a second content source based on the second information from a group of numerous content sources;
the back-end-server processor being further configured to obtain the repair or maintenance information for the sending to the first apparatus from the first content source; and
the back-end-server processor being further configured to obtain the repair or maintenance information for the sending to the second apparatus from the second content source.

79. A method comprising:
establishing communication with a proximate device;
establishing communication with a back-end server;
identifying the proximate device using the local communication and receiving status information from the proximate device;
presenting to the user an indication of the status of the proximate device;
receiving from the user a request for repair or maintenance information relating to the proximate device;
signaling to a back-end server an indication of the status of the proximate device, information relating to the user and an indication of properties of the proximate device and to responsively receive from the back-end server corresponding repair or maintenance information; and
presenting of the received repair or maintenance information to the user before repair or maintenance of the proximate device is performed according to the repair or maintenance information.

80. The method of claim 79, further comprising:
prompting the user to approve the repair or maintenance of the proximate device according to the repair or maintenance information and responsively causing receiving a corresponding approval from the user and transferring at least a portion of the repair or maintenance information to the proximate device.

81. A method comprising:
enabling concurrent communications with numerous remote apparatuses;
receiving from a first apparatus first information comprising an indication of a status of a first proximate device that is proximate to the first apparatus, information relating to a user of the first apparatus and an indication of properties of the first proximate device and responsively sending to the first apparatus corresponding repair or maintenance information;
receiving from a second apparatus second information comprising an indication of a status of a second proximate device that is proximate to the second apparatus, information relating to a user of the second apparatus and a direct or indirect indication of properties of the second proximate device and to responsively send to the second apparatus corresponding repair or maintenance information;
determining a first content source based on the first information from a group of numerous content sources;
determining a second content source based on the second information from a group of numerous content sources;
obtaining the repair or maintenance information for the sending to the first apparatus from the first content source; and
obtaining the repair or maintenance information for the sending to the second apparatus from the second content source.

82. The method of claim 81, further comprising containing in the first information a first user interface definition for the first proximate device, the first user interface definition being configured to provide user access to the first proximate device by adapting the first apparatus to produce a first user interface for controlling the first proximate device.

83. The method of claim 81, further comprising containing in the second information a second user interface definition for the second proximate device, the second user interface definition being configured to provide user access to the second proximate device by adapting the second apparatus to produce a second user interface for controlling the second proximate device.

84. The method of any one of claim 81, further comprising accessing a content source database, the content source database comprising communication addresses for the numerous content sources and metadata for determining the first content source and the second content source, the method further comprising determining the first content source and the second content source using the content source database.

85. The method of claim 81, wherein the metadata comprises information defining compatibility of different content sources with different devices and error states.

86. A non-transitory computer-readable medium storing instructions which, when executed by one or more processors, cause the one or more processors to perform the method of claim 79.

87. A non-transitory computer-readable medium storing instructions which, when executed by one or more processors, cause the one or more processors to perform the method of claim 81.
